(19) United States
(12) Patent Application Publication
(10) Pub. No.: US 2011/0153146 A1
(43) Pub. Date: Jun. 23, 2011

(54) METHOD FOR ON BOARD DIAGNOSTICS AND SYSTEM FOR ON BOARD DIAGNOSTICS

(75) Inventor: Stefan Wikner, Goteborg (SE)

(73) Assignee: VOLVO LASTVAGNAR AB

(21) Appl. No.: 13/060,461

(22) PCT Filed: Sep. 8, 2008
(86) PCT No.: PCT/SE08/00504

§ 371 Date: Feb. 24, 2011

(51) Int. Cl. G01M 15/09

(52) U.S. Cl. 701/29

(57) ABSTRACT

In a method for on board diagnostics for detecting a charge air leakage in a vehicle, air is compressed by a turbine with variable geometry and fed to the combustion engine. Steps are performed of feeding compressed air to the engine without fuel supply to the engine; estimating a boost pressure from a current vane geometry of the variable geometry turbine; measure the actual boost pressure; and comparing the estimated boost pressure with the measured boost pressure.

### BACKGROUND AND SUMMARY

The invention relates to a method for on board diagnostics and a system for an on board diagnostics method.

It is known that legal as well as aftermarket demands push the development of more advanced On Board Diagnostics (OBD) to detect malfunctioning devices in vehicles.

In order to detect a charge air leakage in the charge air system of a combustion engine, it is known in the art to compare e.g. a modelled value of the inlet manifold pressure with a measured value. A leakage is detected if the measured value is lower than the modelled value. The model can be based on a couple of known variables such as engine and/or turbine speed, engine torque, amount of fuel injected, actuator position of a variable geometry turbine, advance angle, needle opening pressure of the injector. The advance angle and the needle opening pressure of the injector are mostly excluded from the models as these variables do not change once the engine control strategy is finalized. It is also quite difficult to find out the relationship between charge air pressure and these variables.

It is desirable to provide an on board diagnostics method for detecting a leakage in the charge air system of a combustion engine. It is also desirable to provide a system for performing a method for on board diagnostics. Still another object of the present invention is to detect a malfunctioning inlet manifold pressure sensor and/or a VGT position sensor.

A method for on board diagnostics for detecting a charge air leakage is proposed in a combustion engine, wherein air is compressed by a turbine with variable geometry (VGT) and fed to the combustion engine. Compressed air is fed to the engine without fuel supply to the engine during motoring, e.g., when the engine is producing a negative torque on the crankshaft. A boost pressure is estimated from a current vane geometry of the variable geometry turbine. The actual boost pressure is measured and the estimated boost pressure is compared with the measured boost pressure.

An engine equipped with a VGT has the capability to control the pressure of the engine's inlet manifold. If a charge air leakage is present, the control capability is reduced. During normal engine operations, there are many factors as well as many uncertainties influencing the control strategy of the engine. Among the various factors, particularly the amount of fuel and the timing strongly influence the charge air pressure. Favourably, the invention allows for a leakage detection method independent of the engine control strategy. By feeding compressed air into the engine without feeding fuel the factors which are most strongly influencing the engine control strategy can be left out, as neither an amount of fuel nor the timing when to feed the fuel needs to be considered in the analysis.

Favourably, less testing and optimization is needed. More accurate decisions can be taken as there are fewer uncertainties to be considered. The on board diagnostics is simplified and easier to develop, to optimize, to verify and to validate.

Variable geometry turbochargers (VGTs) are turbochargers usually designed to allow the effective aspect ratio (A/R Ratio) of the turbo to be altered as operational conditions change. A VGT has movable vanes which can direct exhaust flow onto the turbine blades. The vane angles are adjusted via an actuator. The angle of the vanes varies throughout the engine rotational speed range to optimize turbine behaviour.

An optimum aspect ratio at low engine speeds differs from that at high engine speeds. If the aspect ratio is too large, the turbo will fail to create boost at low speeds. If the aspect ratio is too small, the turbo will choke the engine at high speeds, leading to high exhaust manifold pressures, high pumping losses, and ultimately lower power output. By altering the geometry of the turbine housing as the engine accelerates, the turbo's aspect ratio can be maintained at its optimum. Because of this, VGTs have a minimal amount of lag, have a low boost threshold, and are very efficient at higher engine speeds. A common implementation known in the art is a set of several aerodynamically-shaped vanes in the turbine housing near the turbine inlet. As these vanes move, the area between the tips of them changes, thereby leading to a variable aspect ratio. The vanes can be controlled by a membrane actuator which can be identical to that of a wastegate. Alternatively, an actuator for electric servo actuated vanes can be used.

According to a favourable development of the invention a presence of a leak can be determined if the difference between the measured and the estimated boost pressure is larger than a predetermined value. Favourably, known tolerances of components employed in the method, such as a pressure sensor and the like, can be considered. A reasonable estimation of the estimated boost pressure can be made if the difference between the measured and the estimated boost pressure is larger than an average value of the tolerances of said components.

According to a favourable development of the invention the estimated boost pressure can be determined during an operational state of engine braking of the engine.

Engine braking is the act of using the energy-requiring compression stroke of the internal combustion engine to dissipate energy and slow down a vehicle. Compression braking is a common legal term for the same mechanism. Large trucks can use a device called an exhaust brake to increase the effectiveness of engine braking.

Compression in an engine is driven by the forward momentum of the vehicle as well as the angular momentum of the flywheel of the engine. When a driver downshifts to spin the engine at high angular velocity (or RPM) without pressing on the accelerator pedal, the engine converts energy from the vehicle's kinetic energy into a temperature increase in the fuel-air mixture. These hot gases are exhausted from the vehicle and heat is transferred from engine components to the air. This energy conversion occurs because most four stroke internal combustion engines require compression of the fuel-air mixture before ignition, in order to extract useful mechanical energy from the expansion. Diesel engines are adiabatic and have no spark plugs and use energy transferred to air charge during compression to directly ignite the mixture when the fuel is injected.

Engine braking is always active in all non-hybrid vehicles with an internal combustion engine, regardless of transmission type. Engine braking passively reduces wear on brakes and helps a driver maintain control of the vehicle. It is always active when the foot is lifted off the accelerator, the transmission is not in neutral, the clutch is engaged and a freewheel is not engaged. This is also often called engine drag.

According to a favourable development of the invention the actual vane geometry of the turbine can be determined by monitoring a position of an actuator for varying the vane geometry of the turbine.

Advantageously, during the engine braking phase, an air leak in the charge air system can be detected by monitoring the position of the VGT actuator. A boost pressure can be estimated from the position of the actuator. Depending on the dynamics of the system a first order state space model could be used. This can be derived from the efficiency of the turbo and other physical parameters of the system. However numerical methods are more commonly used where samples are taken for the different actuator positions and correlated with charge air pressure. Comparison of the estimated boost pressure with the measured boost pressure indicates if a leak is present in the charged air.

According to a favourable development of the invention the measured boost pressure can be determined based on an actual engine and/or turbine speed. By doing so, the accuracy of the method can be increased. Considering the engine speed and/or the turbine speed is particularly favourable in dynamic mode. The turbine speed reacts faster than the boost pressure if a leak is present. The boost pressure varies slowly until reaching a stationary condition, e.g. a demanded boost pressure by a engine control unit. Taking into account the turbine speed is advantageous for a dynamic system. Measurement and estimation of the actual boost pressure can be done quicker. Preferably, at least the measured boost pressure can be extracted from an actual air mass flow through the engine. The air mass flow is depending on the engine speed. As the presence of a leakage in the charge air, the air mass flow is altered and the engine speed will be sensitive to this variation. The air mass flow correlates to the boost pressure.

According to a another aspect of the invention a system for an on board diagnostics method is proposed according to one of the preceding method steps, wherein a calculating unit is provided for determining an estimated boost pressure from a current vane geometry of a variable geometry turbine and comparing the estimated boost pressure with a measured boost pressure. The calculating unit can be integrated in the engine control unit or an appropriate vehicle control unit

Further, a computer program is proposed comprising a computer program code adapted to perform a method for on board diagnostics or for use in a method according to one of the described method steps when said program is run on a programmable microcomputer. Favourably, the computer program can be adapted to be downloaded to a control unit or one of its components when run on a computer which is connected to the internet. The preferred method for on board diagnostics can be easily implemented in a control unit which is arranged in the vehicle.

Further, a computer program product stored on a computer readable medium, is proposed comprising a program code for use in a method on a computer according to one of the preceding on board diagnostics method steps. Favourably, the computer program product can be implemented in a control unit of a vehicle.

### BRIEF DESCRIPTION OF THE DRAWINGS

The present invention may best be understood from the following detailed description of the embodiment, but not restricted to the embodiment, wherein is shown schematically:

FIG. 1 a preferred engine equipped with a variable geometry turbine;

FIG. 2a-c a set of characteristic curves indicating a VGT position (FIG. 2a), a boost pressure (FIG. 2b) and a brake demand (FIG. 2c) in a normally operating charge air system of the engine in FIG. 1; and

FIG. 3a-c a set of characteristic curves indicating a VGT position (FIG. 3a), a boost pressure (FIG. 3b) and a brake demand (FIG. 3c) related to the engine in FIG. 1 comprising a leakage in the charge air system.

### DETAILED DESCRIPTION

In the drawings, equal or similar elements are referred to by equal reference numerals. The drawings are merely schematic representations, not intended to portray specific parameters of the invention. Moreover, the drawings are intended to depict only typical embodiments of the invention and therefore should not be considered as limiting the scope of the invention.

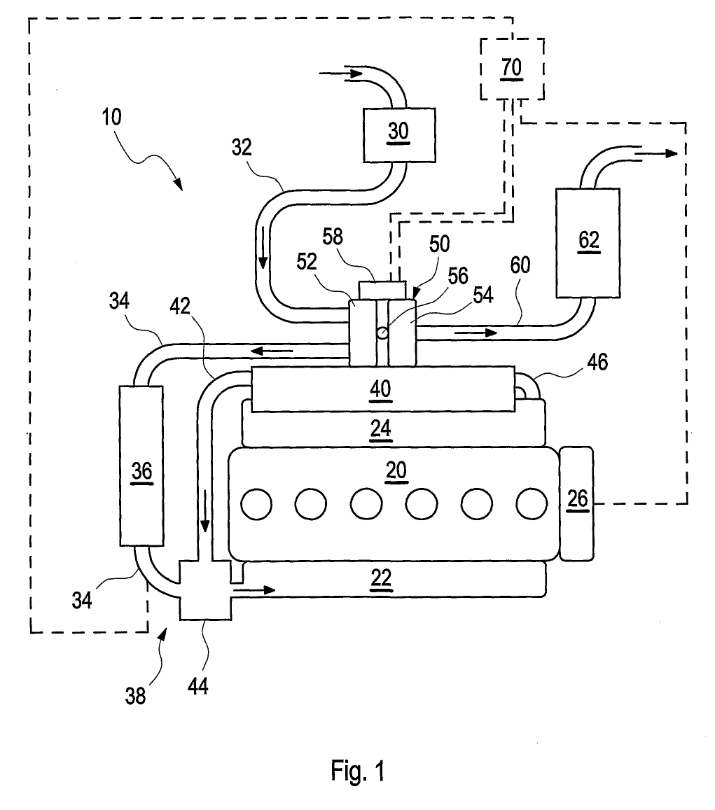

FIG. 1 depicts schematically an engine 20 of a vehicle (not shown) equipped with a turbocharger 50 comprising a variable geometry turbine 54. Air is fed to an intake manifold 22 of the engine 20 through air pipes 32 and 34. The air pipe 32 is equipped with an air filter 30. Between the air pipes 32 and 34 a compressor 52 of the turbocharger 50 is arranged. A charge air cooler 36 is arranged in the air pipe 34. Compressed air is fed through the air pipe 34 to the charge air cooler 38 into the intake manifold 22.

The engine 20 is by way of example equipped with an EGR system, wherein exhaust from an exhaust manifold 24 of the engine 20 is fed into an EGR cooler 40. An air pipe 42 feeds the cooled exhaust to an EGR mixing chamber 44 where the exhaust is mixed with the charged air from the charge air cooler 36. An EGR actuator 46 directs more or less exhaust gas to the EGR cooler 40 and to the EGR system depending on operational conditions of the engine 20.

Exhaust which can bypass the EGR cooler 40 is fed into the turbine 54 of the turbocharger 50 and guided through an exhaust pipe 60 to a muffler/silencer and/or an exhaust aftertreatment system 62, which may be equipped with one or more catalysts, particle filters and the like (not shown).

The pressure of the charge air can be measured with a pressure sensor 38 coupled to the air pipe 34 between the charge air cooler 36 and the EGR mixing chamber 44. The engine 20 can be equipped with a crank speed sensor 26 attached to the crank shaft (not shown) of the engine 20, indicating the rotational speed of the engine 20.

The turbo charger 50 is provided with a turbo speed sensor 56 which senses the rotational speed of the turbine and an optional position sensor 58 which senses the position of an actuator (not shown) varying the position of vanes (not shown) in the turbine from a first position where the vanes are in a closed or nearly closed position with minimum air throughput to a second position where the vanes are in a maximum open position with a maximum air throughput.

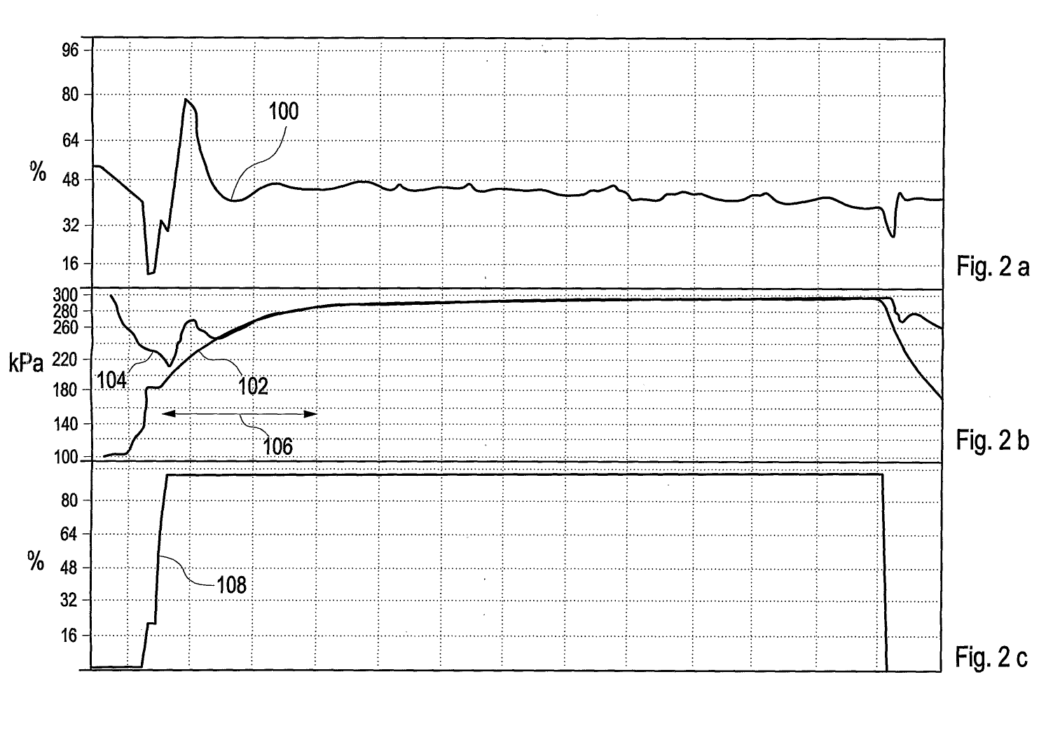

If no leakage is present in the charge air, FIGS. 2a-2c illustrate the behaviour of the VGT position sensed by the position sensor 58 (curve 100 in FIG. 2a), the behaviour of the measured boost pressure sensed by the pressure sensor 40 (curve 104 in FIG. 2b) in comparison to a boost pressure demand 102 and the behaviour of the brake demand (curve 108 in FIG. 2c) as a function of time while the engine 20 is operated in an engine braking mode.

The actual position of the actuator is indicated e.g. as a percentage of the maximum open position of the vanes which can be read by the position of the actuator moving the vanes between minimum and maximum position. The position of the actuator is correlated with the boost pressure 104. For instance, for a demanded boost pressure of 280 kPa, in a given example system, the position of the actuator corresponds to vanes 48% open. The numbers given in the example are only for clarifying the behaviour of the system.

The boost pressure 104 and the boost pressure demand 102 need some time to reach a steady state. A transition time in demand is used to protect the components and have a more natural and comfortable brake behaviour. For instance, the boost pressure demand 102 increases from a low value in a transition region 106 to a steady state of 280 kPa. The measured boost pressure 104 shows an overswing in the beginning and an increases virtually simultaneously with the boost pressure demand 102. The overswing is an effect of bad calibration of the control function.

The brake demand 108 for engine braking is about 90%. Relative to the maximum braking performance this parameter is received from the demand function of the vehicle. It depends on the position of the engine brake lever that the driver can move, which can be set into a plurality of different brake demands.

During engine braking, no fuel is injected into the engine 20.

These curves are characteristic for the engine 20 and illustrate the characteristics of the engine 20. Such characteristic curves are known and stored in maps which are available for a control unit which provides the engine control strategy. The engine control strategy is based on such characteristic curves.

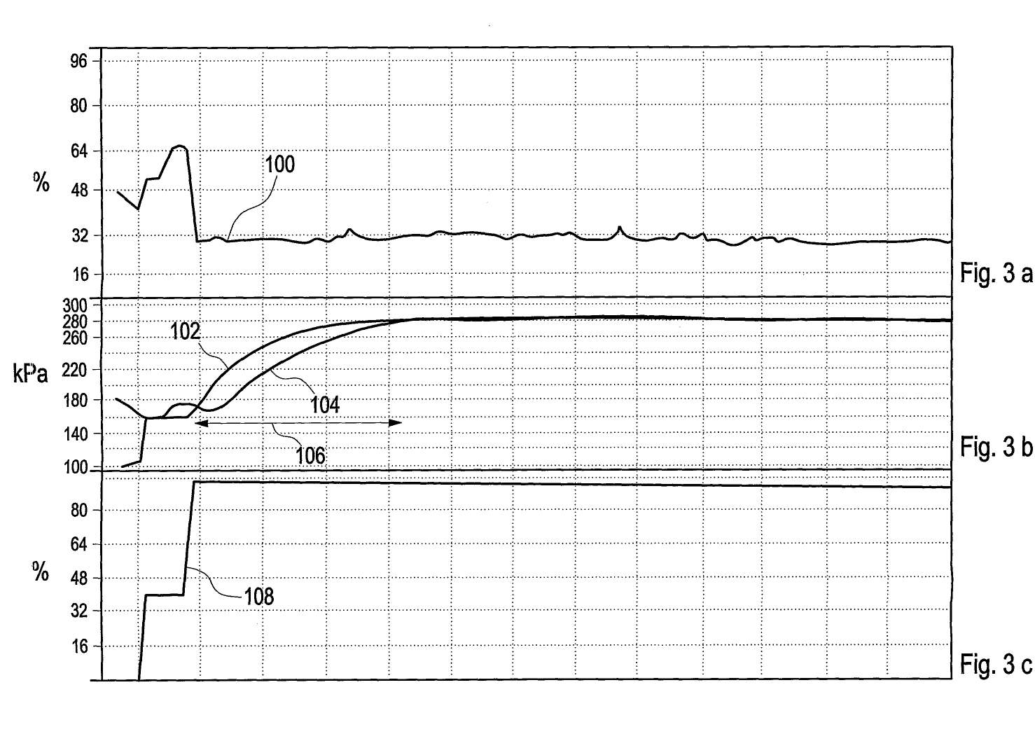

FIGS. 3a-3c reveal the behaviour in case of a leakage in the charge air. FIGS. 3a-3c illustrate the behaviour of the VGT position sensed by the position sensor 58 (curve 100 in FIG. 3a), the behaviour of the measured boost pressure sensed by the pressure sensor 40 (curve 104 in FIG. 3b) in comparison to a boost pressure demand 102 and the behaviour of the brake demand (curve 108 in FIG. 3c) as a function of time while the engine 20 is operated in an engine braking mode.

As can be seen, the position of the actuator is has changed from 48% in FIG. 2a to 32% in FIG. 3a for an example leakage of 12 mm in the air pipe 34 downstream of the charge air cooler 36.

Likely, the measured boost pressure 104 in FIG. 3b is now well below the boost pressure 104 in FIG. 2b in the transition region 106.

The brake demand 108 shows a pronounced step at the beginning of the transition region 106 of the boost pressure 104.

According to the invention, compressed air is fed to the engine 20 without fuel supply to the engine 20, particularly during engine braking. It's also possible to feed compressed air to the engine when the engine is running but then there will be fuel injected. It can be used to raise the temperature of the engine. A boost pressure is estimated from the current vane geometry of the variable geometry turbine 54 by preferably sensing the position of the actuator which moves the vanes. The estimated boost pressure is compared to the measured actual boost pressure 104.

By comparing the estimated boost pressure and the measured boost pressure 104 a probable pressure difference can be detected. In case of a leakage of the charge air, the estimated boost pressure will be well above the measured boost pressure 104. Thus it can be determined if a leak is present and/or a malfunctioning sensor if the difference between the measured boost pressure 104 and the estimated boost is larger than a predetermined value, e.g. the average tolerance of the position sensor 58 and/or pressure sensor 40.

Advantageously, it takes only a few seconds for the on board diagnostics of a leakage in the charge air in a vehicle when the preferred method is employed.

Favourable, a method for on board diagnostics is provided which is more accurate than methods known in the art and which needs less parameters for the analysis.

1. A method for on board diagnostics for detecting a charge air leakage in a vehicle, wherein air is compressed by a turbine with variable geometry and fed to the combustion engine, comprising:
feeding compressed air to the engine without fuel supply to the engine;
estimating a boost pressure from a current vane geometry of the variable geometry turbine;
the measuring an actual boost pressure;
comparing the estimated boost pressure with the measured boost pressure.

2. The method according to claim 1, comprising determining if a leak is present if the difference between the measured and the estimated boost pressure is larger than a predetermined value.

3. The method according to claim 1, wherein the estimated boost pressure is determined during an operational state of engine braking of the engine.

4. The method according to claim 1, comprising determining the actual vane geometry of the turbine by monitoring a position of an actuator for varying the vane geometry of the turbine.

5. The method according to claim 5, comprising extracting at least the measured boost pressure from an actual air mass flow through the engine.

6. A system for an on board diagnostics method according to claim 1, comprising a calculating unit for determining an estimated boost pressure from a current vane geometry of a variable geometry turbine and comparing the estimated boost pressure with a measured boost pressure.

7. A vehicle comprising a system according to claim 7.

8. A computer comprising a computer program code for use in a method according to claim 1.

9. A computer according to claim 8 arranged to download the code when the computer is connected to the internet.

10. program product stored on a A non-transitory computer readable medium, comprising program code for use in a method according to claim 1.
